(19) United States
(12) Patent Application Publication
(10) Pub. No.: US 2008/0062589 A1
(43) Pub. Date: Mar. 13, 2008

(54) HIGH-VOLTAGE POWER SUPPLIES

(75) Inventor: Richard B. DRABING, Los Altos, CA (US)

Correspondence Address: LEVINE BAGADE HAN LLP, 2483 EAST BAYSHORE ROAD, SUITE 100, PALO ALTO, CA, 94303, US

(73) Assignee: Artificial Muscle, Inc., Menlo Park, CA (US)

(21) Appl. No.: 11/670,385

(22) Filed: Feb. 1, 2007

Related U.S. Application Data
(60) Provisional application No. 60/825,094, filed on Sep. 8, 2006.

(51) Int. Cl. H01F 27/42; H02H 5/04

(52) U.S. Cl. 361/37; 323/356; 363/15

(57) ABSTRACT

The present the invention provides power supplies and circuitry for powering high-voltage devices.

### CROSS-REFERENCE TO RELATED APPLICATIONS

This application claims the benefit of priority to U.S. Application Ser. No. 60/825,094 filed on Sep. 8, 2007.

### FIELD OF THE INVENTION

The present invention is related to power supplies and associated circuitry for powering high-voltage devices.

### BACKGROUND

High-voltage power supplies are commonly used and well-known for powering devices which require a high DC voltage. Most high-voltage power supplies include a transformer or inductor for converting or stepping-up a relatively low DC source voltage to a relatively high DC output voltage. A transformer approach includes a primary winding to which the input voltage is applied and one or more secondary windings formed from a number of turns according to the desired step-up or output voltage. Such power supplies also include transistors and various diodes and/or diode bridges and capacitors, where the diode components effect full-wave rectification of the AC voltage outputted from secondary winding(s) and the capacitors are employed to reduce ripple in the DC voltage outputted from the operating frequency. Components such as the transformer, diodes, and capacitors used in high-voltage power supply circuits must be able to withstand the effects of high voltages and, as such, this results in increased circuit size and weight and increases the cost of the power supply.

Thus, there continues to be an interest and need in developing high-voltage power circuitry to address the size and cost limitations of prior art power supplies. In particular, it would greatly beneficial and highly advantageous to provide a high-voltage power supply made of minimal light-weight components to reduce the overall size and cost of the power supply.

### SUMMARY OF THE INVENTION

The present invention includes novel circuitry for powering devices requiring a high-voltage supply. The power circuitry of the present invention includes at least a transformer circuit, an oscillator stabilizer circuit and a voltage multiplier circuit. The transformer circuit includes a transformer having a primary or input side and a secondary or output side, where the primary side is to be coupled to an input voltage and the secondary side is coupled to the voltage multiplier circuit. The oscillator stabilizer circuit is coupled to the primary side of the transformer for stabilizing the oscillating AC output voltage. The voltage multiplier circuit is coupled to the output of the secondary side of the transformer for stepping-up the value of the voltage to the desired output voltage. In certain embodiments, the power circuitry farther includes a temperature monitoring circuit coupled to the output of the primary side of the transformer to turn off the power circuit upon it reaching a maximum temperature.

The present invention also provides power supplies comprising the subject power circuitry, where the components forming the power circuitry of the present invention are relatively small and arranged in such a manner to reduce the number and size of the necessary components, and thus reducing the overall space requirements and total cost of the power supply.

The present invention also includes methods for powering devices requiring a high-voltage supply, where the methods may be performed using the power circuitry or power supplies of the present invention.

These and other features, objects and advantages of the invention will become apparent to those persons skilled in the art upon reading the details of the invention as more fully described below.

### BRIEF DESCRIPTION OF THE DRAWINGS

The invention is best understood from the following detailed description when read in conjunction with the accompanying schematic drawings. To facilitate understanding, the same reference numerals have been used (where practical) to designate similar elements that are common to the drawings. Included in the drawings are the following:

FIG. 1 is a block diagram of the power circuitry of the present invention;

FIG. 2 is a schematic representation of a power supply circuit of the present invention; and

FIG. 3 is a schematic representation of another power supply circuit of the present invention.

Variation of the invention from that shown in the figures is contemplated.

### DETAILED DESCRIPTION OF THE INVENTION

The present invention provides power circuitry and power supplies for use in powering high-voltage devices where the available voltage is relatively low and is required to be “stepped up” to a relatively high voltage to adequately power the device. The power circuitry/supply is configured to allow the user to select the desired output voltage where the output voltage is proportional to the input voltage.

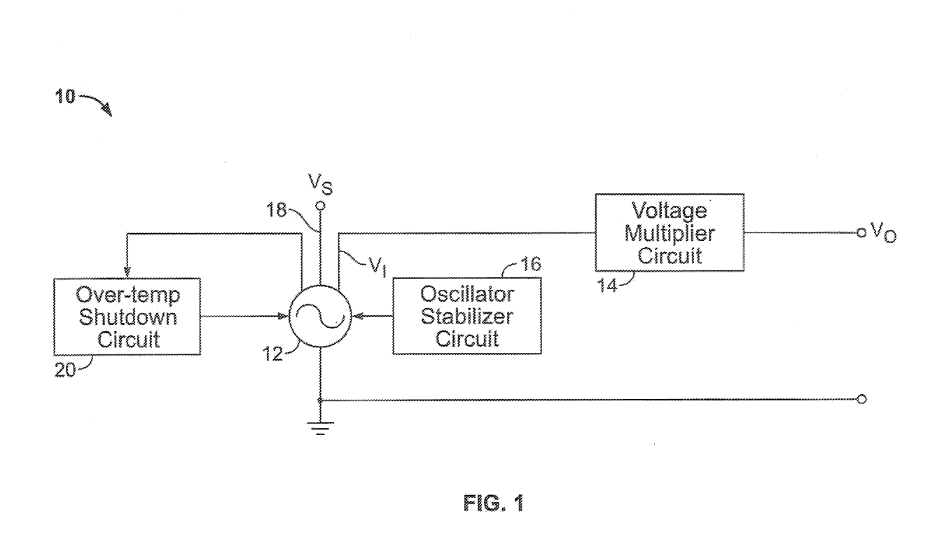

The general configuration of the power supply circuit 10 of the present invention is provided in the block diagram of FIG. 1. Power circuitry/supply 10 includes transformer circuit 12 having an input 18 coupled to a relatively low DC source signal Vs (e.g., 1 to 48 volt range). Transformer circuit 12 converts the source signal to an oscillating AC signal. An oscillator stabilizer circuit 16 is employed to stabilize the oscillating AC voltage signal V_{I} produced by transformer circuit 12. The output of transformer circuit 12 is coupled to the input side of a voltage multiplier circuit 14. Multiplier circuit 14 converts oscillating AC voltage signal V_{I} to a “stepped up” DC voltage output V_{O} which is substantially proportional to the input voltage V_{I} As is discussed in greater detail below, the configuration of multiplier circuit, i.e., the number of “stages” that it employs, is selected to provide the desired output signal V_{O} in order to power a high-voltage device (not shown). Optionally, the subject power circuitry/supply 10 may further include a shutdown circuit 20 for shutting down or turning off transformer circuit 12 should its operating temperature rise above a specified maximum temperature (e.g., 100° C.) in order to protect the circuit components.

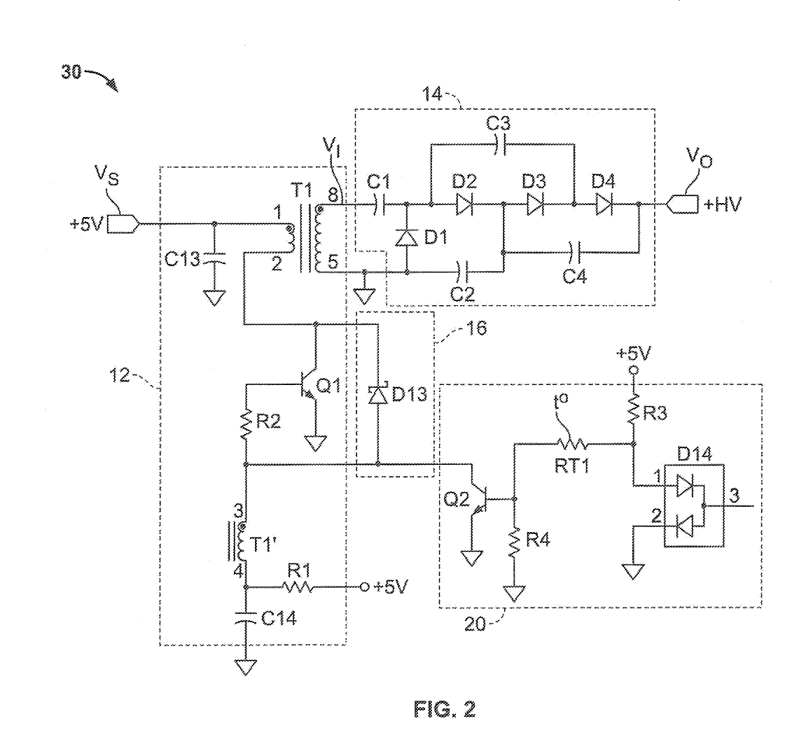

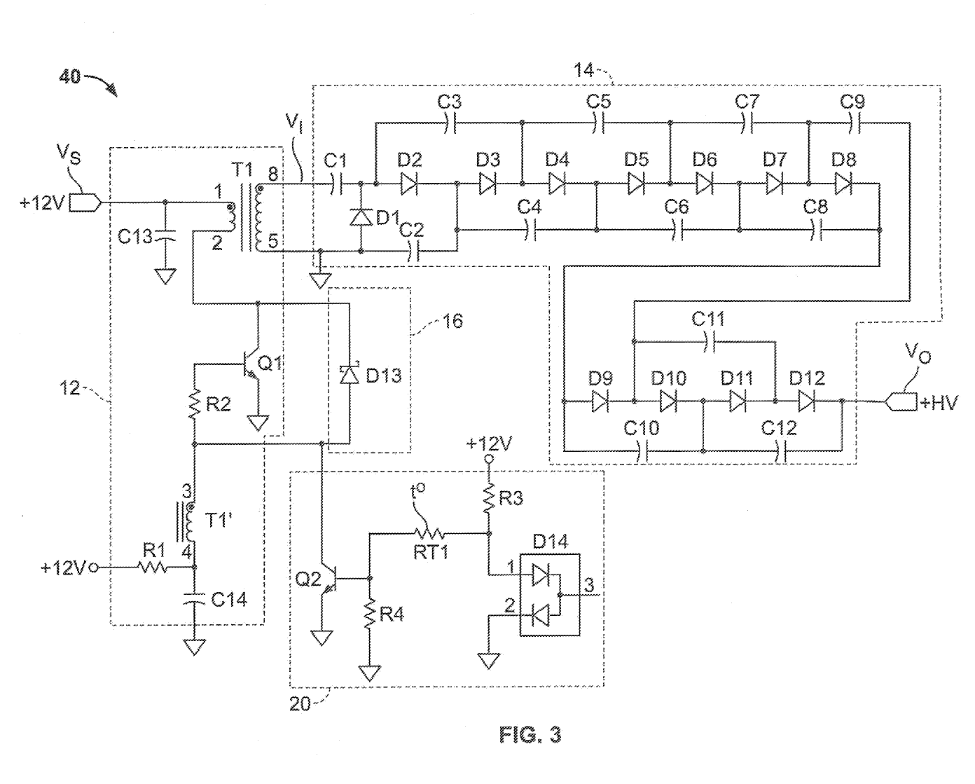

The power circuitry of the present invention is now further illustrated and described with respect to the exemplary circuit designs of FIGS. 2 and 3; however, the invention is not to be limited by these examples as they are merely illustrative of the invention.

The power circuits 30 of FIG. 2 and 40 of FIG. 3 each includes a transformer circuit 12, a voltage multiplier circuit 14, an oscillator stabilizer circuit 16 and an over-temperature shutdown circuit 20, as generally described with respect to FIG. 1. The transformer, oscillator and over-temperature shutdown circuits 12, 16, 20 of power circuits 30 and 40 are structurally and functionally equivalent. The respective multiplier circuits 14 are functionally similar to each other in that V_{O} is stepped up to be proportionately greater than V_{I.}Their structures, however, will vary depending on the desired or necessary magnitude of the voltage (V_{O}) required to power a particular device, the magnitude of the available source voltage V_{S}, and the capacity or size of the transformer circuit used to provide the input signal V_{I}.

In each of FIGS. 2 and 3, transformer circuit 12 is a Hartley oscillator circuit.

The Harley oscillator is comprised of transformer T1, capacitors C13 and C14, transistor Q1, and resistors R1 and R2. Transformer T1 includes a feedback winding T1′ which causes the DC input signal V_{I} received on the primary side or primary winding (designated with a “1” in the figure) of transformer T1 to oscillate, thereby converting the DC signal to an AC signal. While any variable frequency oscillator circuit may be employed by the transformer circuit of the present invention, a Hartley oscillator has the advantage of being able to oscillate very low source voltages (i.e., below ±1V DC), providing a wide range of frequencies and being very easy to tune. However, its waveform output amplitude may not be as stable as other oscillators. In order to stabilize the resulting AC signal, a stabilizer circuit 16 is provided.

Stabilizer circuit 16 comprises a Schottky diode D13 coupled to the output of the primary winding (designated with a “2” in the figures). Schottky diode D13 in the base circuit of transistor Q1 uses the voltage on the collector of Q1 to limit the drive voltage of the transistor base when the amplitude of feedback voltage from winding T1′ approaches the ground reference. In this manner, diode D13 is used to effectively stabilize or control the amplitude of the feedback voltage. This provides a steady, although not constant, output voltage throughout the full load range. Load regulations of better than 5% have been achieved with stabilizer circuit 16.

The stabilized AC output of transformer T1 (i.e., V_{I}) is coupled to the input of voltage multiplier circuit 14. As mentioned, voltage multiplier circuit 14 functions to step-up the AC voltage signal provided by transformer circuit 12 to the desired or selected output voltage V_{O} which is in turn supplied to the device (not shown) to be powered. Voltage multiplier circuit 14 includes one or more voltage multiplier “stages” depending on how much the voltage is to be stepped-up. Each stage includes two diodes and two capacitors. For multiplier circuits containing more than one multiplier stage, the various stages are connected in cascade with each other. For example, the voltage multiplier circuit of FIG. 2, includes two stages where diodes D1 and D2 and capacitors C1 and C2 collectively provide the first stage and diodes D3 and D4 and capacitors C3 and C4 collectively provide the second stage. In power circuit 40 of FIG. 3, the voltage multiplier circuit includes four additional stages for a total of six stages, where diodes D5 and D6 and capacitors C5 and C6 collectively provide the third stage, diodes D7 and D8 and capacitors C7 and C8 collectively provide the fourth stage, diodes D9 and D10 and capacitors C9 and C10 collectively provide the fifth stage, and diodes D11 and D12 and capacitors C11 and C12 collectively provide the sixth stage.

The magnitude of V_{O} is obtained by adding the voltages across the stages of circuit 14, e.g., 2X, 4X, 6X, etc. where X is the value of the magnitude of V_{I}. For example, where V_{I} is ±500 V AC, V_{O} can be stepped up to a DC voltage having a magnitude which is a multiple of ±500, e.g., ±1 kV DC, 2kV DC, 3 kV DC, etc. The ratio of V_{O} to V_{I} for the illustrated power circuits is N:1, where N is the number of stages in multiplier circuit 14. Thus, V_{O}:V_{I} for power circuit 30 is 4:1, and is 12:1 for power circuit 40

The respective values of the diodes and capacitors for the multiplier stages are selected based on output voltage (V_{O}) requirements, and input voltage (V_{I}) and source voltage (V_{S}) magnitude, as well as component cost and size constraints. For example, the diodes may withstand up to 1000 volts and the capacitors may have a capacitance of 4.7 nf @ 1000 volts rating. Selection of the capacitance values may also be based on AC signal frequency and magnitude, where the higher values of capacitance are better able to reduce output ripple.

The power circuitry of the present invention may further include an over-temperature shutdown circuit 20 to protect against overheating. Shutdown circuit 20 includes a transistor Q2 coupled to the base of transistor Q1 of transformer circuit 12, and a reference circuit which includes a negative temperature coefficient thermistor RT1, resistors R3 and R4 and reference diode D14 which collectively control the drive voltage of transistor Q2. Under normal operating temperatures (i.e., up to about 100° C.), transistor Q2 is operating. As the temperature of the power circuit increases, the resistance of thermistor RT1 decreases. When the resistance of the thermistor becomes sufficient to achieve the necessary drive voltage of transistor Q2, transistor Q2 turns on thereby pulling transistor Q1 to ground, shutting down transformer circuit 12. Where an overload condition arises, the drive voltage of transistor Q1 of transformer circuit 12 becomes insufficient to turn on or keep itself on. This results in a decrease in the oscillation amplitude of the feedback voltage from winding T1′ and ultimately a complete stoppage, or shutdown, of oscillation. Over-temperature shutdown circuit 20 may be configured such that overheating of the circuit for any reason, including that caused by a high ambient temperature, will shut down transformer circuit 12 and prevent damage to it, and the remainder of the power circuit components.

The present invention also provides methods associated with the subject power circuit for powering high-voltage devices. The methods may all comprise the act of providing a suitable power supply, circuit, etc. Such provision may be performed by the end user. In other words, the act of “providing” merely requires the end user obtain, access, approach, position, set-up, activate, power-up or otherwise act to provide the requisite object used in the subject method. Likewise, the various acts of mechanical and/or electrical actuation are included in some of the subject methods.

Yet another aspect of the invention includes kits having any combination of devices, circuits or components described herein—whether provided in packaged combination or assembled by a technician for operating use. The kit may further include various other components for use with the power supplies including mechanical or electrical connectors, etc.

The subject kits may also include written instructions for the use of the power supplies and/or their assembly. These instructions may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g., CD-ROM, diskette, etc. In yet other embodiments, the actual instructions are not present in the kit, but means for obtaining the instructions from a remote source, e.g., via the Internet, are provided. An example of this embodiment is a kit that includes a web address where the instructions can be viewed and/or from which the instructions can be downloaded. As with the instructions, this means for obtaining the instructions is recorded on suitable media.

As for other details of the present invention, such as the types of devices that may be powered by the subject power circuits/supplies, many such devices are generally known or appreciated by those with skill in the art. The same may hold true with respect to method-based aspects of the invention in terms of additional acts as commonly or logically employed.

The invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. Any number of the individual components, subassemblies or circuits shown may be integrated in their design. Such changes or others may be undertaken or guided by the principles of design for assembly. In addition, where a range of values is provided, it is understood that every intervening value, between the upper and lower limit of that range and any other stated or intervening value in that stated range is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in the appended claims, the singular forms “a,” “an,” “said,” and “the” include plural referents unless the specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Without the use of such exclusive terminology, the term “comprising” in the claims shall allow for the inclusion of any additional element—irrespective of whether a given number of elements are enumerated in the claim, or the addition of a feature could be regarded as transforming the nature of an element set forth n the claims. Stated otherwise, unless specifically defined herein, all technical and scientific terms used herein are to be given as broad a commonly understood meaning as possible while maintaining claim validity.

In all, the breadth of the present invention is not to be limited by the examples provided. That being said, we claim:

1. A power circuit comprising:
a transformer circuit comprising a Hartley oscillator circuit and an input for receiving a source of voltage;
a voltage multiplier circuit comprising an input coupled to an output of the transformer circuit; and
a stabilizer circuit comprising a Schottky diode coupled to the transformer circuit.

2. The power circuit of claim 1 further comprising a temperature monitoring circuit coupled to the transformer circuit, wherein the temperature monitoring circuit shuts down the power circuit when an over-temperature condition is reached.

3. A method of providing a relatively high DC voltage when provided with a relatively low DC source voltage, the method comprising:
accessing the DC source voltage;
transforming the DC source voltage to an oscillating AC voltage;
stabilizing the oscillating AC voltage; and
converting the stabilized AC voltage to a DC voltage, wherein the magnitude of the DC voltage is a multiple of the magnitude of the stabilized AC voltage.

4. The method of claim 3, wherein the step of transforming comprising using a Hartley oscillator circuit.

5. The method of claim 3, wherein the step of stabilizing comprises using a Schottky diode.

6. The method of claim 3, further comprising ceasing the method when an over-temperature condition is reached.
